(19) United States
(12) Patent Application Publication
(10) Pub. No.: US 2006/0210244 A1
(43) Pub. Date: Sep. 21, 2006

(54) Image recording system and image recording apparatus

(76) Inventors: Fusayuki Fujita, Yamatokoriyama (JP); Masahiro Wada, Souraku-gun (JP); Koji Yakushiji, Yamatokoriyama (JP)

Correspondence Address: NIXON & VANDERHYE, PC, 901 NORTH GLEBE ROAD, 11TH FLOOR, ARLINGTON, VA, 22203, US

(21) Appl. No.: 10/554,859

(22) PCT Filed: Apr. 8, 2004
(86) PCT No.: PCT/JP04/05102

§ 371 Date: Oct. 28, 2005

(30) Foreign Application Priority Data
Apr. 28, 2003 (JP) 2003-123964

(51) Int. Cl. H04N 5/91

(52) U.S. Cl. 386/94

(57) ABSTRACT

A transmitting apparatus transmits encrypted image data created by encrypting image data by using an authentication code as an encryption key and the first converted information created by digesting the authentication code by using a one-way function to an image recording apparatus. The image recording apparatus creates the second converted information by digesting an authentication code received directly from the user by using a one-way function, decrypts the received encrypted image data into image data by using the received authentication code as a decryption key if the created second converted information and the received first converted information coincide, and creates and records an image based on the decrypted image data.

This application is the national phase under 35 U.S.C. §371 of PCT International Application No. PCT/JP2004/005102 which has an International filing date of Apr. 8, 2004 and designated the United States of America.

### TECHNICAL FIELD

The present invention relates to an image recording system that collates information received by an image recording apparatus with information received from a user and records an image if these pieces of information correspond to each other, and relates to the image recording apparatus.

### BACKGROUND ART

A method for recording an image with an image recording apparatus functioning as a printing apparatus is in transition from a conventional method in which an image is recorded with an image recording apparatus connected to a transmitting apparatus for transmitting information through a cable, such as a personal computer (PC), to a method in which the image recording apparatus and the transmitting apparatus are connected to a communication network, image data is transmitted from the transmitting apparatus to the image recording apparatus through the communication network, and the image recording apparatus outputs an image. In such an environment, recorded matters produced by recording images on sheets according to instructions from a plurality of users are mixed in a storing unit for recorded matters, and there is a possibility that a recorded matter may be taken away by other user. The information handled by the image recording apparatus may contain confidential information, such as documents describing a corporate secret, and it is difficult to maintain the confidentiality of information handled by the image recording apparatus under a condition in which many unspecified people can take away recorded matters.

Therefore, there was developed an image recording apparatus that stores image data without recording an image when the image recording apparatus receives the image data transmitted from a transmitting apparatus, and records the image after the user directly operates the image recording apparatus and inputs a record instruction. Japanese Patent Application Laid-Open No. 3-269756 (1991) discloses a technique in which a personal identification number is transmitted together with image data from a transmitting apparatus to an image recording apparatus, and the image recording apparatus comprises means that is directly operated by a user for inputting a personal identification number, and records an image after receiving an input of the same personal identification number and verifying the user. Moreover, in order to prevent image data flowing on a communication network or image data stored in an image recording apparatus from being read, Japanese Patent Application Laid-Open No. 6-124178 (1994) discloses a technique in which a transmitting apparatus transmits encrypted image data and a key code to an image recording apparatus, and the image recording apparatus stores encrypted image data in advance and records an image by decrypting the image data by using the key code when it receives a correct password.

Since the technique disclosed in Japanese Patent Application Laid-Open No. 3-269756 (1991) transmits a personal identification number for verifying a user together with image data, if the personal identification number is read on a communication network, there arises a problem that others can pretend to be the user. Also, since the technique disclosed in Japanese Patent Application Laid-Open No. 6-124178 (1994) transmits information necessary for decrypting image data together with the image data, if the information is read on a communication network, there arises a problem that others can decrypt the image data.

### DISCLOSURE OF THE INVENTION

The present invention has been made with the aim of solving the above problems, and it is an object of the invention to provide an image recording system capable of preventing others from pretending to be a user by transmitting information for verifying the user to an image recording apparatus after digesting the information by a one-way function, and causing the image recording apparatus to digest directly received information and verify the user by collating the digested information, and provide the image recording apparatus.

Further, it is another object of the invention to provide an image recording system capable of preventing decryption of image data by others by transmitting information for verifying a user after encrypting image data by using an encryption key, transmitting the information after digesting it by a one-way function, and causing the image recording apparatus to decrypt the image data by using directly received information as a decryption key, and provide the image recording apparatus.

An image recording system according to the present invention is an image recording system comprising an image recording apparatus, and a transmitting apparatus, connected to the image recording apparatus, for transmitting information to the image recording apparatus, and characterized in that the transmitting apparatus includes: first converting means for creating first converted information by converting first information; and means for transmitting the created first converted information and an image record instruction to the image recording apparatus, and the image recording apparatus includes: means for receiving second information; second converting means for creating second converted information by converting the received second information; means for determining whether or not the received first converted information and the created second converted information correspond to each other; and means for recording an image according to the received image record instruction if a determination is made that the first converted information and the second converted information properly correspond to each other.

An image recoding system according to the present invention is an image recording system comprising an image recording apparatus, and a transmitting apparatus, connected to the image recording apparatus, for transmitting information to the image recording apparatus, and characterized in that the transmitting apparatus includes: first converting means for creating first converted information by converting first information; means for creating encrypted image data by encrypting image data by using the first information as an encryption key; and means for transmitting the created first converted information and encrypted image data to the image recording apparatus, and the image recording apparatus includes: means for receiving second information; second converting means for creating second converted information by converting the received second information; determining means for determining whether or not the received first converted information and the created second converted information coincide; means for decrypting the received encrypted image data by using the second information as a decryption key; and means for recording an image created based on the decrypted image data if a determination is made that the first converted information and the second converted information coincide.

An image recording system according to the present invention is characterized in that the first converting means and the second converting means digest information by using a one-way function.

An image recording apparatus according to the present invention is an image recording apparatus for recording an image according to an image record instruction received from other apparatus, and characterized by comprising: means for receiving an image record instruction and first converted information from other apparatus; means for receiving one information; converting means for creating second converted information by converting the received information; means for determining whether or not the received first converted information and the created second converted information correspond to each other; and means for recording an image according to the received image record instruction if a determination is made that the first converted information and the second converted information properly correspond to each other.

An image recording apparatus according to the present invention is an image recording apparatus for recording an image created based on image data received from other apparatus, and characterized by comprising: means for receiving encrypted image data and first converted information from other apparatus; receiving means for receiving one information; converting means for creating second converted information by converting the received information; determining means for determining whether or not the received first converted information and the created second converted information coincide; means for decrypting the received encrypted image data by using the information received by the receiving means as a decryption key; and means for recording an image created based on the decrypted image data if the determining means determines that the first converted information and the second converted information coincide.

An image recording apparatus according to the present invention is characterized in that the converting means digests information by using a one-way function.

According to the present invention, in a system in which information for verifying a user is transmitted together with an image record instruction to the image recording apparatus from the transmitting apparatus, and the image recording apparatus records an image when it receives corresponding information by operation of the user, the transmitting apparatus transmits the first converted information created by converting the first information for verifying the user, and the image recording apparatus converts the second information received by operation of the user into the second converted information, and records an image if the first converted information and the second converted information properly correspond to each other.

According to the present invention, in a system in which information for verifying a user is transmitted together with image data to the image recording apparatus from the transmitting apparatus and the image recording apparatus records an image when it receives corresponding information by operation of the user, the transmitting apparatus transmits the first converted information created by converting the first information for verifying the user and encrypted image data created by encrypting image data by using the first information as an encryption key, and the image recording apparatus converts the second information received by operation of the user into the second converted information, decrypts the encrypted image data by using the second information as a decryption key if the first converted information and the second converted information coincide, and records an image.

According to the present invention, the first converted information and the second converted information are created by digesting information by using a one-way function.

### BRIEF DESCRIPTION OF THE DRAWINGS

FIG. 1 is a conceptual view showing an outline of the present invention;

FIG. 2 is a block diagram showing the structure of an image recording system of the present invention and the internal structure of an image recording apparatus of the present invention;

FIG. 3 is a flowchart showing the processing step of transmitting an image record instruction from a transmitting apparatus to the image recording apparatus;

FIGS. 4A and 4B are schematic views showing an example of the output screen of the transmitting apparatus when transmitting an image record instruction;

FIG. 5 is a conceptual view showing an example of the storage contents stored in a storing unit of the image recording apparatus;

FIG. 6 is a flowchart showing the processing step of recording an image by the image recording apparatus;

FIG. 7 is a flowchart showing the processing step of recording an image by the image recording apparatus; and

FIGS. 8A and 8B are schematic views showing an example of the output screen in an operation unit of the image recording apparatus when recording an image.

### BEST MODE FOR CARRYING OUT THE INVENTION

The following description will specifically explain the present invention, based on the drawings illustrating an embodiment thereof.

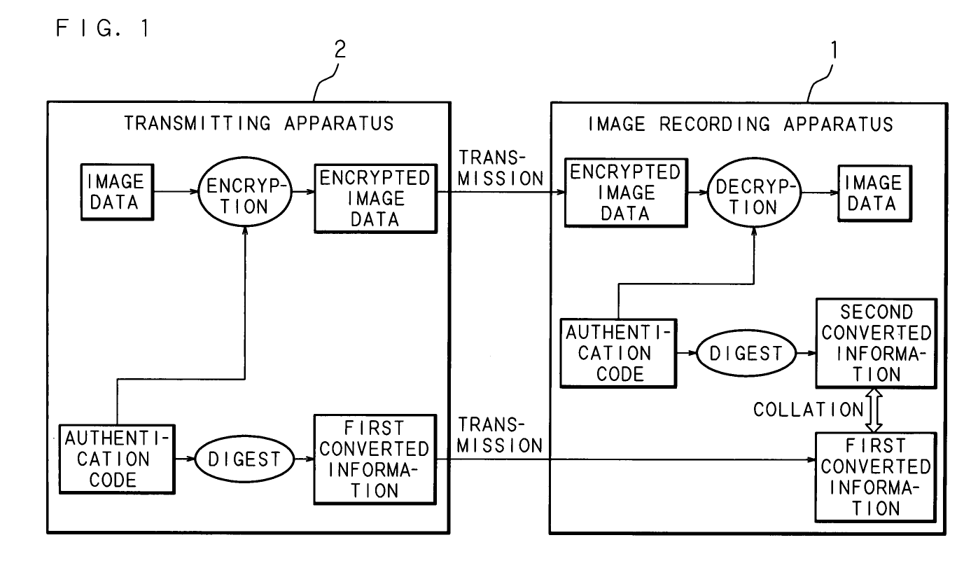

FIG. 1 is a conceptual view showing an outline of the present invention. An image recording system of the present invention comprises an image recording apparatus 1 of the present invention that is a printing apparatus, and a transmitting apparatus 2 according to the present invention connected to the image recording apparatus 1. The transmitting apparatus 2 is composed of a computer such as a personal computer (PC), creates image data to be recorded as an image by the image recording apparatus 1, encrypts the image data by using an authentication code, which is the first information according to the present invention and inputted by operation of the user or stored in advance, as an encryption key, and transmits the encrypted image data to the image recording apparatus 1. The transmitting apparatus 2 digests the authentication code by using a one-way function such as a one-way hash function to create the first converted information, and transmits the first converted information to the image recording apparatus 1. The image recording apparatus 1 receives an authentication code that is the second information according to the present invention by operation of the user, digests the received authentication code by using a one-way function to create the second converted information, and collates the created second converted information with the received first converted information to verify the user. When the second converted information and the first converted information coincide, it is verified that the user of the transmitting apparatus 2 and the user operating the image recording apparatus 1 are the same user, and then the image recording apparatus 1 decrypts the received encrypted image data into image data by using the received authentication code as a decryption key, and creates and records an image based on the decrypted image data.

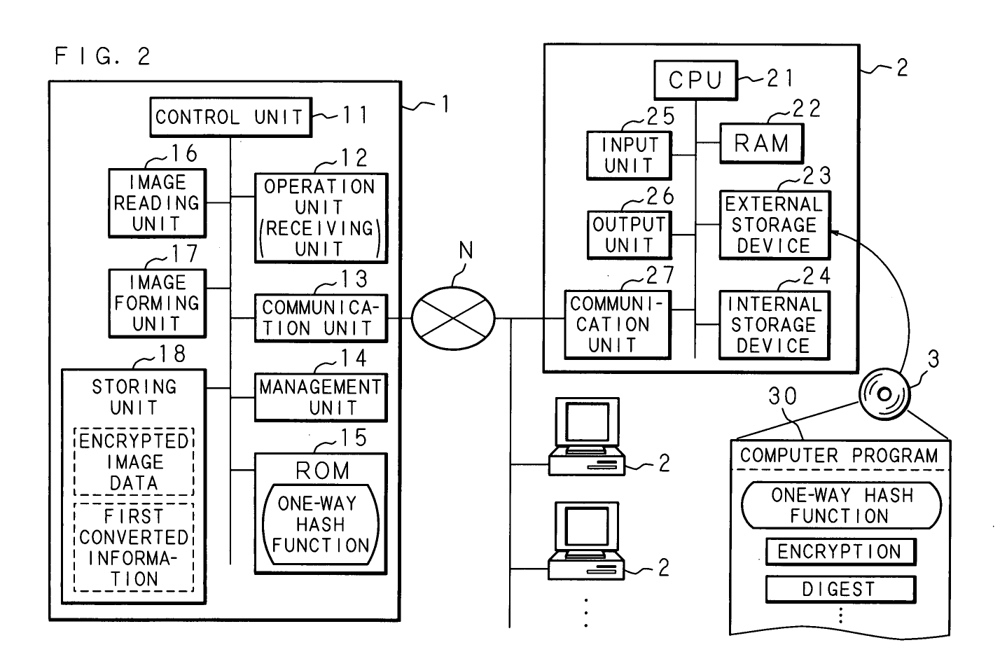

FIG. 2 is a block diagram showing the structure of an image recording system of the present invention and the internal structure of the image recording apparatus of the present invention. The image recording apparatus 1 comprises a control unit 11 composed of a CPU for performing operations, a RAM for storing temporary information concerning the operations, etc., and connected to a ROM 15 storing a control program for controlling the image recording apparatus 1, and the control unit 11 controls the image recording apparatus 1 entirely according to the control program stored in the ROM 15. Moreover, a management unit 14 that is a memory for storing management information indicting the status of the image recording apparatus 1 is connected to the control unit 11, and the control unit 11 refers to the management information stored in the management unit 14 and controls the image recording apparatus 1 based on the referred management information. Further, an image reading unit 16 for scan-reading an image recorded on a sheet and creating electronic image data based on the read image, and an image forming unit 17 for forming an image from the image data and outputting the formed image by recording it on a recording sheet are connected to the control unit 11, and the image recording apparatus 1 functions as a copying machine for copying an image read by the image reading unit 16. In addition, a storing unit 18 composed of a hard disk or a non-volatile memory is connected to the control unit 11, and the storing unit 18 stores image data. Moreover, an operation unit 12 for receiving an operation from the user is connected to the control unit 11, and the operation unit 12 comprises display means such as a liquid crystal panel for displaying information necessary for the operation, and input means such as a touch panel or ten-key through which information such as a control command is inputted by operation of the user.

Further, a communication unit 13 connected to a communication network N, such as a LAN, is connected to the control unit 11, and the communication unit 13 exchanges information with an external apparatus through the communication network N. A plurality of transmitting apparatuses 2, 2, . . . are connected to the communication network N, the communication unit 13 receives image data transmitted from a transmitting apparatus 2 through the communication network N and stores the received image data in the storing unit 18, the image forming unit 17 can form an image from the image data and output the image, and the image recording apparatus 1 functions as a printing apparatus. In addition, the image recording apparatus 1 can transmit the image data created by reading an image with the image reading unit 16 to the transmitting apparatus 2 from the communication unit 13 through the communication network N, and functions as a scanning apparatus. Moreover, the communication unit 13 can perform facsimile communication, and functions as a facsimile machine for exchanging image data with an external facsimile machine by facsimile communication through an external communication network (not shown) connected to the communication network N.

The transmitting apparatus 2 comprises a CPU 21 for performing operations, a RAM 22 for storing temporarily information created for the operations, an external storage device 23 such as a CD-ROM drive, and an internal storage device 24 such as a hard disk, and reads a computer program 30 from a recording medium 3 such as a CD-ROM in the external storage device 23, stores the read computer program 30 in the internal storage device 24 and loads the computer program 30 into the RAM 22, and the CPU 21 executes processes necessary for the transmitting apparatus 2, based on the loaded computer program 30. Further, the transmitting apparatus 2 comprises a communication unit 27 connected to the communication network N, and transmits an image record instruction to the image recording apparatus 1 through the communication network N. In addition, the transmitting apparatus 2 comprises an input unit 25 such as a keyboard or a mouse, and an output unit 26 such as a liquid crystal display or a CRT display, and is constructed to receive operations such as an input of information from an operator.

The computer program 30 includes a one-way hash function for digesting information, and the ROM 15 of the image recording apparatus 1 stores a similar one-way hash function.

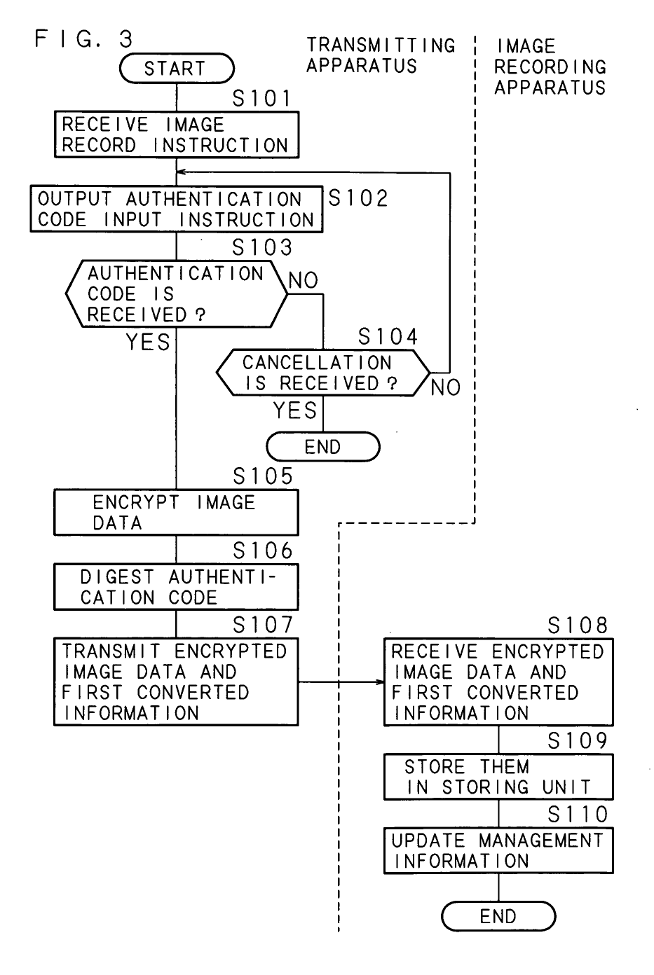

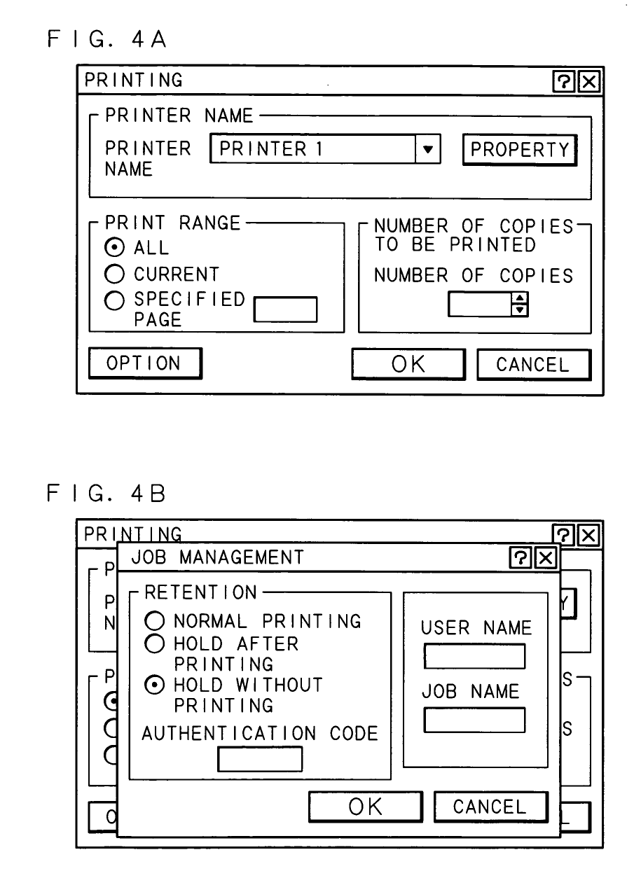

FIG. 3 is a flowchart showing the processing step of transmitting an image record instruction from a transmitting apparatus 2 to the image recording apparatus 1, and FIGS. 4A and 4B are schematic views showing an example of an output screen of the transmitting apparatus 2 when transmitting an image record instruction. On the screen of the output unit 26 as shown in FIG. 4A, when a user selects an image recording apparatus 1 that is a printing apparatus for use in recording an image, inputs a print range and the number of copies to be printed and specifies OK, then the transmitting apparatus 2 receives an image record instruction, such as an instruction to record an image created by the transmitting apparatus 2 that is a PC, at the input unit 25 (S101), and the CPU 21 loads the computer program 30 into the RAM 22, follows the loaded computer program 30, outputs a job management screen as shown in FIG. 4B to the output unit 26, and outputs an instruction to input an authentication code that is the first information according to the present invention for verifying the user (S102). On the job management screen as shown in FIG. 4B, it is possible to select an image recording method from “Normal printing” in which the image data is transmitted and the image is recorded as it is, “Hold after printing” in which the image data is held after recording the image, and “Hold without printing” in which the image data is held until an instruction is directly inputted to the image recording apparatus 1, and when “Hold without printing” is specified, the image recording system of the present invention performs the processes according to the present invention. The CPU 21 monitors reception of an authentication code at the input unit 25 given by inputting the user name, job name and authentication code and specifying OK on the screen by the user as shown in FIG. 4B (S103), and if an authentication code is not received because the user specifies Cancel on the screen shown in FIG. 4B or other reason (S103: NO), then the CPU 21 follows the computer program 30 loaded in the RAM 22, returns the screen to be outputted to the output unit 26 to the screen shown in FIG. 4A, monitors reception of cancellation of image recording (S104), and if cancellation is received at the input unit 25 (S104: YES), the CPU 21 finishes the process, but if cancellation is not received (S104: NO), the CPU 21 returns the process to step S102 and outputs an authentication code input instruction to the output unit 26.

If an authentication code is received in step S103 (S103: YES), then the CPU 21 follows the computer program 30 loaded in the RAM 22, encrypts the image data of an image to be recorded by the image recording apparatus 1 according to a common key method using the received authentication code as an encryption key to create encrypted image data (S105), digests the authentication code by using a one-way hash function to create the first converted information (S106), and transmits the encrypted image data and the first converted information from the communication unit 27 to the image recording apparatus 1 through the communication network N(S107).

The image recording apparatus 1 receives the encrypted image data and the first converted information transmitted from the transmitting apparatus 2 through the communication network N at the communication unit 13 (S108), the control unit 11 follows the control program stored in the ROM 15 and stores the received encrypted image data and first converted information in the storing unit 18 (S109), updates the management information stored in the management unit 14 by adding the information about the encrypted image data and first converted information stored in the storing unit 18 (S110), and finishes the process. Note that, in the above-mentioned processes, the process of receiving the input of an authentication code is performed every time an image record instruction is received at the transmitting apparatus 2, but it may be possible to store an authentication code in the transmitting apparatus 2 in advance and perform the encrypting and digesting process by using the stored authentication code.

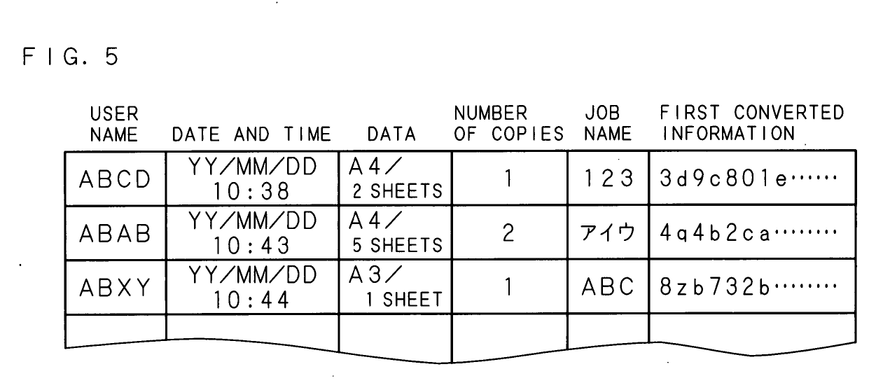

FIG. 5 is a conceptual view showing an example of the storage contents stored in the storing unit 18 of the image recording apparatus 1. Information such as the user name, date and time, number of copies, and job name are stored in association with encrypted image data, and further the first converted information is stored.

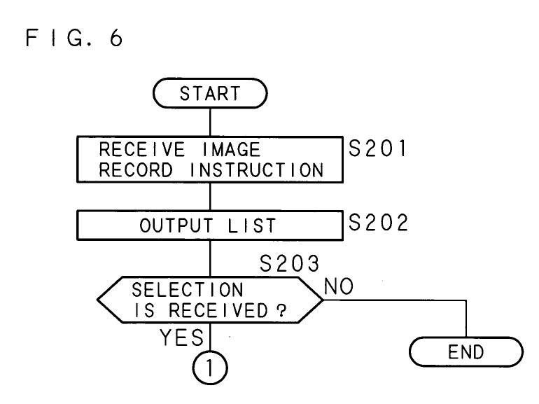

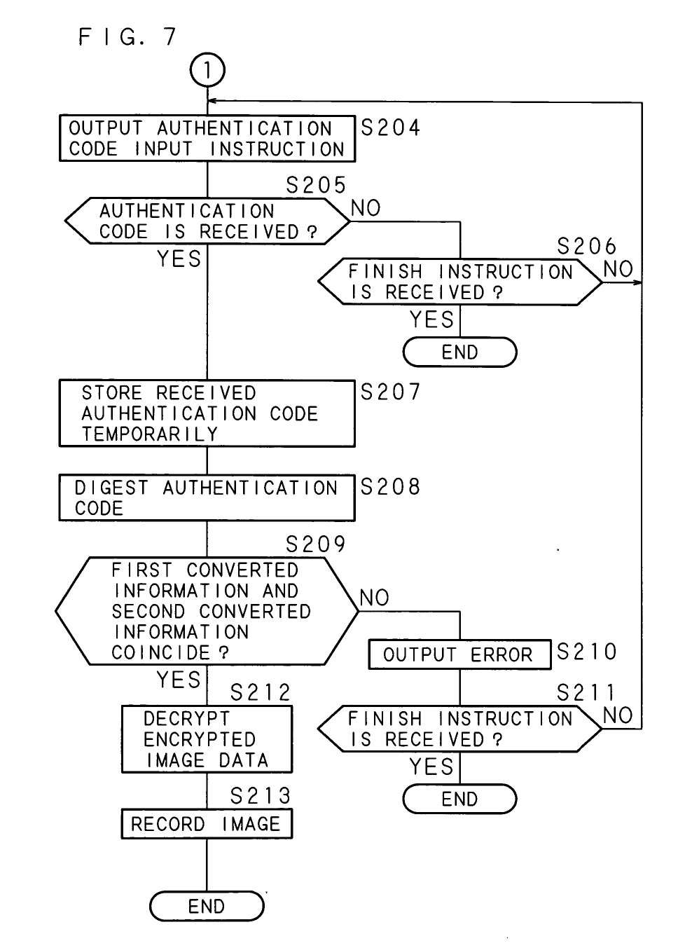

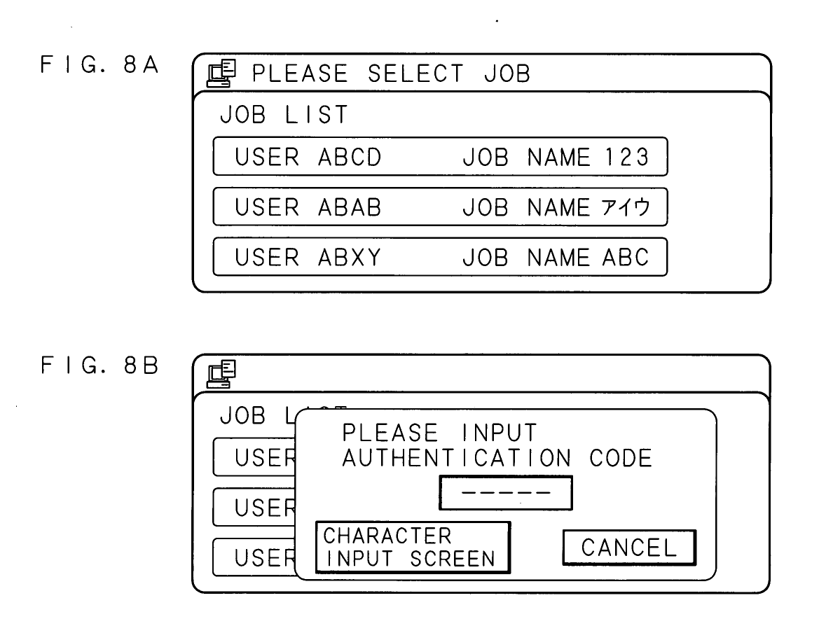

FIGS. 6 and 7 illustrate a flowchart showing the processing step of recording an image by the image recording apparatus 1, and FIGS. 8A and 8B are schematic views showing an example of an output screen of the operation unit 12 of the image recording apparatus 1 when recording an image. The image recording apparatus 1 receives an image record instruction by operation of the user through the operation unit 12 (S201), and the control unit 11 follows a control program stored in the ROM 15 and outputs a list of jobs of image recording corresponding to the respective encrypted image data stored in the storing unit 18 to the display means of the operation unit 12 as shown in FIG. 8A (S202). The control unit 11 monitors reception of job selection made by specifying a job to record an image by the user on the screen as shown in FIG. 8A (S203), and if job selection is not received (S203: NO), the control unit 11 finishes the process, but if job selection is received (S203: YES), the control unit 11 follows the control program stored in the ROM 15 and outputs an authentication code input instruction to the display means of the operation unit 12 (S204). FIG. 8B is an example of the output screen of the operation unit 12 for instructing to input an authentication code, and if an authentication code consists of numerals, the user inputs the authentication code by operating the ten-key of the operation unit 12, but if an authentication code includes characters such as alphabets, the user specifies a character input screen so that the screen for inputting characters is displayed to enable the input of the authentication code. According to the control program stored in the ROM 15, the control unit 11 monitors reception of an authentication code at the operation unit 12 (S205), and if an authentication code is not received (S205: NO), the control unit 11 monitors reception of a finish instruction at the operation unit 12 (S206), and if a finish instruction is received (S206: YES), the control unit 11 finishes the process, but if a finish instruction is not received (S206: NO), the control unit 11 returns the process to step S204 and outputs an authentication code input instruction to the operation unit 12.

In step S205, if an authentication code is received (S205: YES), the control unit 11 follows the control program stored in the ROM 15, temporarily stores the received authentication code (S207), creates the second converted information by digesting the received authentication code by using a one-way hash function (S208), and determines whether or not the first converted information stored in association with the selected job and the second converted information coincide (S209). If the first converted information and the second converted information do not coincide (S209: NO), the control unit 11 follows the control program stored in the ROM 15, outputs an error indicating that the authentication codes do not coincide to the display means of the operation unit 12 (S210), monitors reception of a finish instruction at the operation unit 12 (S211), and finishes the process if a finish instruction is received (S211: YES), or returns the process to step S204 and outputs an authentication code input instruction to the operation unit 12 if a finish instruction is not received (S211: NO). In step S209, if a determination is made that the first converted information and the second converted information coincide (S209: YES), the control unit 11 follows the control program stored in the ROM 15, decrypts the encrypted image data into image data by using the temporarily stored authentication code as a decryption key (S212), creates and records an image on a sheet according to the decrypted image data at the image forming unit 17 (S213), and finishes the process.

As described in detail above, according to the present invention, in an image recording system in which an authentication code is transmitted together with image data to the image recording apparatus 1 from the transmitting apparatus 2, and the image recording apparatus 1 stores the received image data and records an image when the same authentication code is inputted by operation of the user, the transmitting apparatus 2 digests the authentication code by a one-way function and transmits it to the image recording apparatus 1, and similarly the image recording apparatus 1 digests an authentication code received from the user by a one-way function and collates the digested authentication codes with each other to determine whether or not they coincide. Since the information to be transmitted through the communication network N from the transmitting apparatus 2 to the image recording apparatus 1 is information created by digesting an authentication code by a one-way function, even when it is read by others on the communication network, it is difficult for others to know the authentication code that should be inputted to the image recording apparatus 1, and therefore it is possible to prevent others pretending to be a user from causing the image recording apparatus 1 to record an image and it is possible to maintain the confidentiality of the information. Further, according to the present invention, the transmitting apparatus 2 encrypts image data by using an authentication code as an encryption key and transmits the first converted information created by digesting the authentication code and encrypted image data created by encrypting image data to the image recording apparatus 1, and the image recording apparatus 1 decrypts the received encrypted image data by using the received authentication code as a decryption key, and therefore even when the information is read by others on the communication network, it is difficult for others to decrypt the encrypted image data because it is difficult to know the authentication code that is the decryption key from the first converted information, and it is possible to maintain the confidentiality of the information.

Note that this embodiment illustrates a mode in which image data is transmitted from the transmitting apparatus 2, and the image recording apparatus forms an image from the received image data and records it, but the present invention is not limited to this and may be performed in a mode in which the image recording apparatus 1 stores image data in the storing unit 18, and an image record instruction for instructing to create and record an image based on image data stored in the storing unit 18 is transmitted from the transmitting apparatus 2 to the image recording apparatus 1. In this case, it is not necessarily to determine whether or not the first converted information and the second converted information coincide, and it may be possible to perform a mode using the process of determining whether or not they have a predetermined corresponding relationship. In this case, it is also possible to maintain the confidentiality of information by transmitting an authentication code digested by using the present invention and verifying the user.

### INDUSTRIAL APPLICABILITY

As described in detail above, according to the present invention, the transmitting apparatus transmits the first converted information created by converting the first information for verifying a user, the image recording apparatus converts the second information received from a user into the second converted information, and records an image if the first converted information and the second converted information properly correspond to each other, and thus it is possible to prevent others from acquiring the information and pretending to be the user, and it is possible to maintain the confidentiality of information.

Moreover, according to the present invention, the transmitting apparatus transmits the first converted information created by converting the first information for verifying a user and encrypted image data created by encrypting image data by using the first information as an encryption key, and the image recording apparatus converts the second information received from a user into the second converted information, decrypts the encrypted image data by using the second information as a decryption key if the first converted information and the second converted information coincide, and records an image, and therefore even when others have acquired the first converted information and encrypted image data, it is possible to maintain the confidentiality of information because it is difficult to decrypt the encrypted image data.

Further, according to the present invention, since the first converted information and the second converted information are created by converting information by using a one-way function, it is difficult for others to know the information before converted, and it is difficult for others to know the contents of the image by using the information, and thus the present invention has advantageous effects and can maintain the confidentiality of information.

1-6. (canceled)

7. An image recording system comprising:
an image recording apparatus; and
a transmitting apparatus, connected to said image recording apparatus, for transmitting information to said image recording apparatus, wherein
said transmitting apparatus includes a controller capable of performing operations of:
creating first converted information by converting first information; and
transmitting the created first converted information and an image record instruction to said image recording apparatus, and
said image recording apparatus includes:
a receiving unit for receiving second information;
a controller capable of performing operations of:
creating second converted information by converting the received second information; and
determining whether or not the received first converted information and the created second converted information correspond to each other; and
an image forming unit for recording an image according to the received image record instruction if a determination is made that the first converted information and the second converted information properly correspond to each other.

8. The image recording system according to claim 7, wherein said controller of said transmitting apparatus and said controller of said image recording apparatus digest information by using a one-way function.

9. An image recording system comprising:
an image recording apparatus; and
a transmitting apparatus, connected to said image recording apparatus, for transmitting information to said image recording apparatus, wherein
said transmitting apparatus includes:
a controller capable of performing operations of:
creating first converted information by converting first information; and
creating encrypted image data by encrypting image data by using the first information as an encryption key; and
a communication unit for transmitting the created first converted information and encrypted image data to said image recording apparatus, and
said image recording apparatus includes:
a receiving unit for receiving second information;
a controller capable of performing operations of:
creating second converted information by converting the received second information;
determining whether or not the received first converted information and the created second converted information coincide; and
decrypting the received encrypted image data by using the second information as a decryption key; and
an image forming unit for recording an image created based on the decrypted image data if a determination is made that the first converted information and the second converted information coincide.

10. The image recording system according to claim 9, wherein said controller of said transmitting apparatus and said controller of said image recording apparatus digest information by using a one-way function.

11. An image recording apparatus for recording an image according to an image record instruction received from other apparatus, comprising:
a communication unit for receiving an image record instruction and first converted information from other apparatus;
a receiving unit for receiving one information;
a controller capable of performing operations of:
creating second converted information by converting the received information; and
determining whether or not the received first converted information and the created second converted information correspond to each other; and
an image forming unit for recording an image according to the received image record instruction if a determination is made that the first converted information and the second converted information properly correspond to each other.

12. The image recording apparatus according to claim 11, wherein said controller digests information by using a one-way function.

13. An image recording apparatus for recording an image created based on image data received from other apparatus, comprising:
a communication unit for receiving encrypted image data and first converted information from other apparatus;
a receiving unit for receiving one information;
a controller capable of performing operations of:
creating second converted information by converting the received information;
determining whether or not the received first converted information and the created second converted information coincide; and
decrypting the received encrypted image data by using the information received by the receiving unit as a decryption key; and
an image forming unit for recording an image created based on the decrypted image data if a determination is made that the first converted information and the second converted information coincide.

14. The image recording apparatus according to claim 13, wherein said controller digests information by using a one-way function.

15. An image recording system comprising:
an image recording apparatus; and
a transmitting apparatus, connected to said image recording apparatus, for transmitting information to said image recording apparatus, wherein
said transmitting apparatus includes:
first converting means for creating first converted information by converting first information; and
means for transmitting the created first converted information and an image record instruction to said image recording apparatus, and
said image recording apparatus includes:
means for receiving second information;
second converting means for creating second converted information by converting the received second information;
means for determining whether or not the received first converted information and the created second converted information correspond to each other; and
means for recording an image according to the received image record instruction if a determination is made that the first converted information and the second converted information properly correspond to each other.

16. The image recording system according to claim 15, wherein said first converting means and said second converting means digest information by using a one-way function.

17. An image recording system comprising:
an image recording apparatus; and
a transmitting apparatus, connected to said image recording apparatus, for transmitting information to said image recording apparatus, wherein
said transmitting apparatus includes:
first converting means for creating first converted information by converting first information;
means for creating encrypted image data by encrypting image data by using the first information as an encryption key; and
means for transmitting the created first converted information and encrypted image data to said image recording apparatus, and
said image recording apparatus includes:
means for receiving second information;
second converting means for creating second converted information by converting the received second information;
determining means for determining whether or not the received first converted information and the created second converted information coincide;
means for decrypting the received encrypted image data by using the second information as a decryption key; and
means for recording an image created based on the decrypted image data if said determining means determines that the first converted information and the second converted information coincide.

18. The image recording system according to claim 17, wherein said first converting means and said second converting means digest information by using a one-way function.

19. An image recording apparatus for recording an image according to an image record instruction received from other apparatus, comprising:
means for receiving an image record instruction and first converted information from other apparatus;
means for receiving one information;
converting means for creating second converted information by converting the received information;
means for determining whether or not the received first converted information and the created second converted information correspond to each other; and
means for recording an image according to the received image record instruction if a determination is made that the first converted information and the second converted information properly correspond to each other.

20. The image recording apparatus according to claim 19, wherein said converting means digests information by using a one-way function.

21. An image recording apparatus for recording an image created based on image data received from other apparatus, comprising:
means for receiving encrypted image data and first converted information from other apparatus;
receiving means for receiving one information;
converting means for creating second converted information by converting the received information;
determining means for determining whether or not the received first converted information and the created second converted information coincide;
means for decrypting the received encrypted image data by using the information received by said receiving means as a decryption key; and
means for recording an image created based on the decrypted image data if said determining means determines that the first converted information and the second converted information coincide.

22. The image recording apparatus according to claim 21, wherein said converting means digests information by using a one-way function.
